(19) United States
(12) Patent Application Publication
(10) Pub. No.: US 2010/0008464 A1
(43) Pub. Date: Jan. 14, 2010

(54) SYSTEM PROFILING

(75) Inventor: FRANK HELLWIG, Munich (DE)

Correspondence Address: DICKSTEIN SHAPIRO LLP, 1633 Broadway, NEW YORK, NY, 10019, US

(73) Assignee: INFINEON TECHNOLOGIES AG, Neubiberg (DE)

(21) Appl. No.: 12/171,926

(22) Filed: Jul. 11, 2008

(51) Int. Cl. G07C 3/00

(52) U.S. Cl. 377/15

(57) ABSTRACT

An apparatus for profiling a computer system, where the apparatus contains a resolution register, a counter, and a monitor. The resolution register stores a variable, which sets the timing for when the apparatus will create an output that can be used to gauge the system's performance. The counter counts the operations of the system, while the monitor monitors occurrences, activities that occur during each operation. Once the number of operations lapse equal to the variable, a reading is output.

### FIELD OF INVENTION

The present invention relates generally to profiling a computer system, and, in particular to dynamically monitoring the performance of a computer system.

### BACKGROUND OF THE INVENTION

Modern System On Chip Architectures (SoC) usually consist of a plurality of active modules, for example: CPUs, DMAs, IPS with DMA functionality, which are connected over on-chip-bus-systems with a plurality of passive modules, for example memories, interfaces, timers, SOC-components like PLL, etc. The complexity of these systems complicates the ability to analyze their functionality and efficiency. The more complex a system, the less transparency. Thus, when a system is required, for example, to react in real-time and is not meeting this specification, it becomes difficult to understand the factors affecting the performance of the system and to correct issues and/or optimize and/or re-design the system to use the hardware resources more effectively. This analysis is generally referred to as System Profiling.

System Profiling is the analysis of an application on a functional level with respect to where and how the run-time of the system is utilized. This analysis enables developers to detect deficiencies in the use of the system, to analyze the detected deficiencies, and to focus on those parts which promise an optimal power gain for the used optimization effort. When changes are made to the system, System Profiling enables the direct measurement of the impact of the changes on the system.

Known System Profiling solutions are based on performance counters, which read events periodically from CPU or over an external interface. When employing a counter, the events are counted, read and transmitted. These counters often have an overflow function so that a user can observe whether a counter has experienced an overflow from the last time it was read. With a counter, a user can observe the number of events that are executed by the system. However, the user cannot observe instructions in the code being executed or accesses to data structures that cause the events.

When employing a counter, the rate of events executed per CPU cycle and/or instructions executed per clock cycle are calculated by the CPU itself. Thus, the performance calculation can affect the performance of the system itself. The measurement can influence the performance of an application and the results of the measurement.

### SUMMARY OF THE INVENTION

An apparatus for profiling a computer system, where the apparatus contains a resolution register, a counter, and a monitor. The resolution register stores a variable, which sets the timing for when the apparatus will create an output that can be used to gauge the system's performance. The counter counts the operations of the system, while the monitor monitors occurrences, activities that occur during each operation. Once the number of operations lapse equal to the variable, a reading is output.

### BRIEF DESCRIPTION OF THE DRAWINGS

FIG. 1 depicts an apparatus according to an embodiment of the present invention.

FIG. 2 depicts an apparatus according to another embodiment of the present invention.

FIG. 3 depicts an apparatus according to another embodiment of the present invention.

FIG. 4 depicts an apparatus according to another embodiment of the present invention.

FIG. 5 depicts an apparatus according to another embodiment of the present invention.

FIG. 6 depicts a method according to an embodiment of the present invention.

### DETAILED DESCRIPTION OF THE INVENTION

The present apparatus and method provide a transparent system profile using processor cycles, executed instructions and/or events to profile performance of a computer system. The apparatus and method monitor the instructions executed per an adjustable number of CPU cycles and/or the number of events that comprise each executed instruction.

The instructions per cycle (IPC) and events per instruction (EPI) are calculated based at least in part on a variable number of cycles and instructions. Each variable number of cycles for which IPC and EPI are calculated is called a resolution. The IPC and EPI measurements taken at each resolution are the results, also known as the system measurements, of the apparatus and method. Additionally, these results are preferably mapped to the executed code or accessed data area of the computer system to allow further transparency.

Once a result is generated it is preferably stored in memory. In some embodiments, the result is used as a trigger. Results are preferably a rate of instructions or events per an adjustable numbers of cycles or instructions. The memory can store the rates of instruction per cycle, events per instruction, and system data including but not limited to one or more of the system parameters of the instructions, timestamps, instruction pointer values, data read addresses, executed code, and accessed data structures. Because the measurements are performed in the apparatus and not by the CPU, the application and the performance of the CPU are not affected by the measurements.

The present invention profiles a computer system, which includes at least one CPU or alternative processor, by dynamically measuring occurrences executed by the system during operation. Occurrences include, but are not limited to, instructions and/or events executed, and operations include, but are not limited to, CPU cycles and/or instructions executed by the system. Additionally, the results are preferably mapped to the executed code or accessed data area of the computer system. In accordance with the described apparatus, a user can obtain a view of both the instructions executed on a computer system per CPU cycle and/or the events that are executed per instruction.

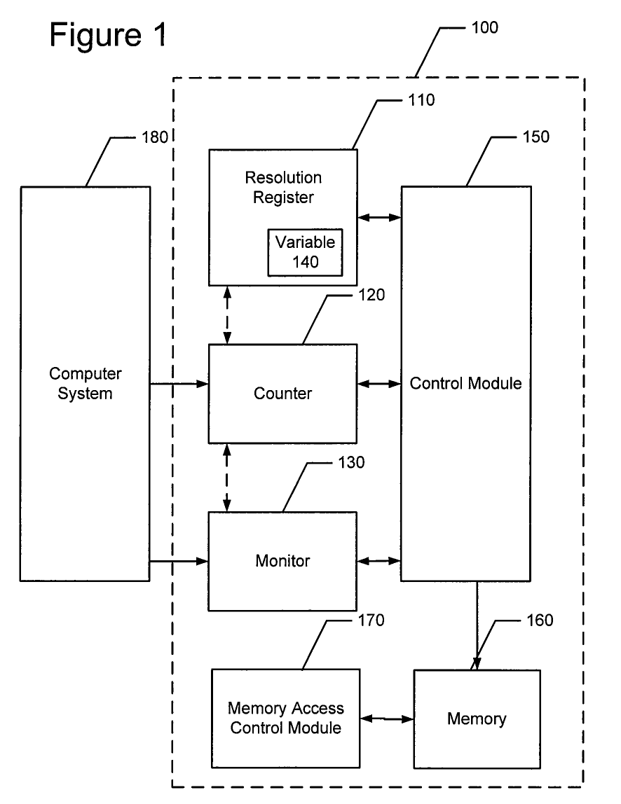

FIG. 1 shows an apparatus 100 according to an embodiment of the present invention. The apparatus 100 profiles computer system 180, which includes one or more CPUs (not shown) to monitor performance.

Apparatus 100 includes a resolution register 110, a counter 120, and a monitor 130, which are controlled by a control module 150. Additionally, a memory 160 is provided that is accessible by memory access control module 170 and control module 150.

Resolution register 110 stores a variable 140 which represents a rate or resolution at which a monitored result will be output. The variable can be preset during manufacture, set by the control module 150, or can be set by an external source (not shown).

Counter 120 counts either instructions or CPU cycles executed by the computer system 180.

Monitor 130 receives the occurrences that comprise the operations executed on the computer system and monitors both the substance of the occurrences as well as the number of occurrences per operation. These occurrences are provided to the monitor 130 by the computer system 180. The counter 120 supplies the monitor 130 with a base count of operations directly or through a connection, or through the mutual connection of the monitor 130 and the counter 120 with the control module 150, When the number of operations that have lapsed equals the limit variable 140 stored in resolution register 110, monitor 130 outputs to the control module 150 a rate of occurrences per the number of operations equal to the limit variable 140, and/or data identifying the actual occurrences and/or mapping each occurrence to the executed code or the accessed data area of the system. In some embodiments, the monitor 130 outputs system data including but not limited to one or more of the system parameters of the instructions, timestamps, instruction pointer values, data read addresses, executed code, and accessed data structures, and event pointer.

After each result is output by the monitor 130 to the control module 150, the control module 150 can reset both the counter 120 and monitor 130. The counter will then begin counting the number of operations and the monitor 130 will monitor occurrences until the number of operations is once again equal to the limit variable 140, at which point the monitor 130 will output a new result. This process can continue as long as the apparatus 100 continues to profile the computer system 180.

In an alternative embodiment, the control module 150 resets only the monitor 130 after a result is output. The current iteration of the counter will then be the starting point for the monitor 130 after reset. When the number of lapsed operations is again equal to the limit variable 140, the monitor 130 will output a result to the control module 150. This process continues as long as the apparatus 100 continues to profile the computer system 180.

The system 180 and the applications operating on the system 180 are not influenced by the measurements (results). The bandwidth used to transmit the results is negligible because the result is created and transmitted outside of the computer system 180. The required bandwidth for storing transmission of the results to external components is reduced compared to the transmission of raw data.

Once a result is output to the control module 150, the control module 150 is configured to export the result to components including but not limited to a trace memory, memory 160. The control module 150 may additionally or alternatively be configured to utilize the result as a trigger for adjusting the profiling process. In one embodiment, the control module 150 changes the variable 140 in the resolution register 110 based in part on the result. In this embodiment, if the result produced at a higher resolution indicates a small number of occurrences per operation, the control module 150 resets the variable so the next result is produced at a lower resolution. For example, a higher resolution utilizes a higher variable to produce a result once a higher number of cycles have lapsed. In another embodiment, if a result exceeds a given value, the control monitor 150 triggers external components to stop the apparatus and/or to read data from memory 160. The control monitor 150 may additionally be configured to start and stop the output of system data to the memory 160 based upon the value of the result. In one embodiment, the control monitor 150 will start or stop the output of system data to the memory 160 when the result is either above, or alternatively below, a threshold value.

When the control module 150 outputs results, memory 160 serves as the repository. The control monitor 150 sends the result received from monitor 130 to memory 160 for storage in real time or at predetermined intervals. The memory 160 can be either internal, i.e., internal temporary memory from which results are read externally by an interface, such as JTAG, or external, i.e., the SRAM of the system. Memory 160 is either a dedicated additional memory for debugging and system profiling purposes or a non-dedicated memory that is not in use by an application.

The memory 160 stores the results as rates including but not limited to the rate of instructions per cycle and/or the events per instruction. Memory 160 optionally stores the system data including but not limited to one or more of the system parameters of the instructions, events monitored timestamps, instruction pointer values, data read addresses, executed code, and accessed data structures. Parallel measurements, for example results at different resolutions, can be concurrently stored in a register or a memory 160. Additionally, the width of the stored results and the bit range of the results can be adjusted to the used resolution in order to reduce the bandwidth utilized.

A memory access control module 170 is connected to the memory to perform retrieval and review of the results. In one embodiment, an external debug interface, such as a JTAG proprietary interface, can be connected to the memory access control module 170 to read the results.

It should be noted that an overflow function is not required if the counter 120, the resolution register 110 and the monitor 130 all have the same count areas or ranges. The disclosed profiling apparatus circuitry is adjusted depending upon whether the computer system can carry out more than one instruction per CPU cycle.

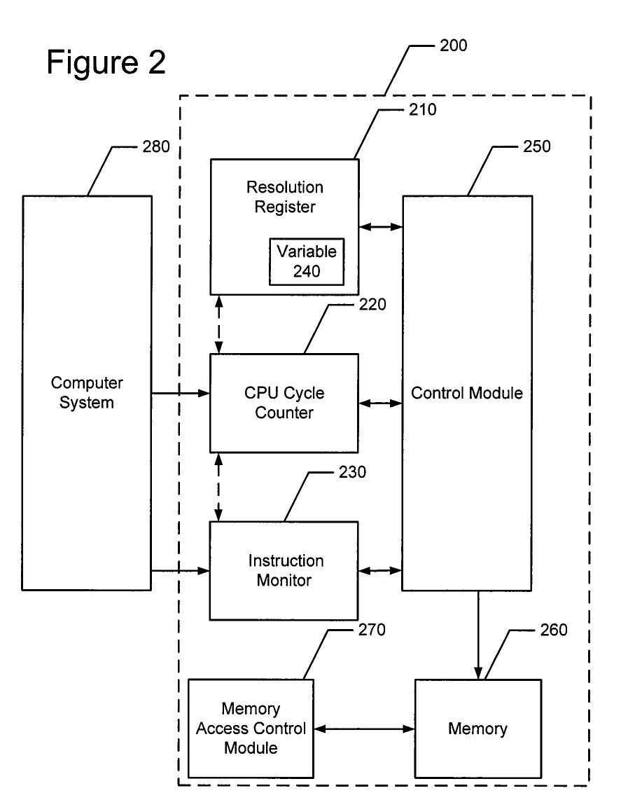

FIG. 2 shows an apparatus 200 according to another embodiment of the present invention. Apparatus 200 is comprised of components similar to those of apparatus 100. For the sake of brevity, the description of FIG. 2 will focus on distinguishing features of this embodiment.

The apparatus 200 measures executed instructions in the computer system 280 directly and dynamically, as executed instructions per a variable number of CPU cycles. Resolution register 210 stores a dynamic limit variable 240, which represents the number of CPU cycles of the system that lapse before a result is output. Counter 220 counts the cycles of the system. Monitor 230 is configured to monitor the instructions executed during the cycles of the system. When the counter 220 has counted a number of cycles equal to limit variable 240 in the resolution register 210, a result is output by instruction monitor 230 to the control module 250.

The embodiment of FIG. 2 is shown as having a single apparatus 200 to profile the computer system 280 at a single resolution. Alternatively, a plurality of apparatuses 200 may be coupled to the same computer system 280 to output results at a plurality of resolutions simultaneously.

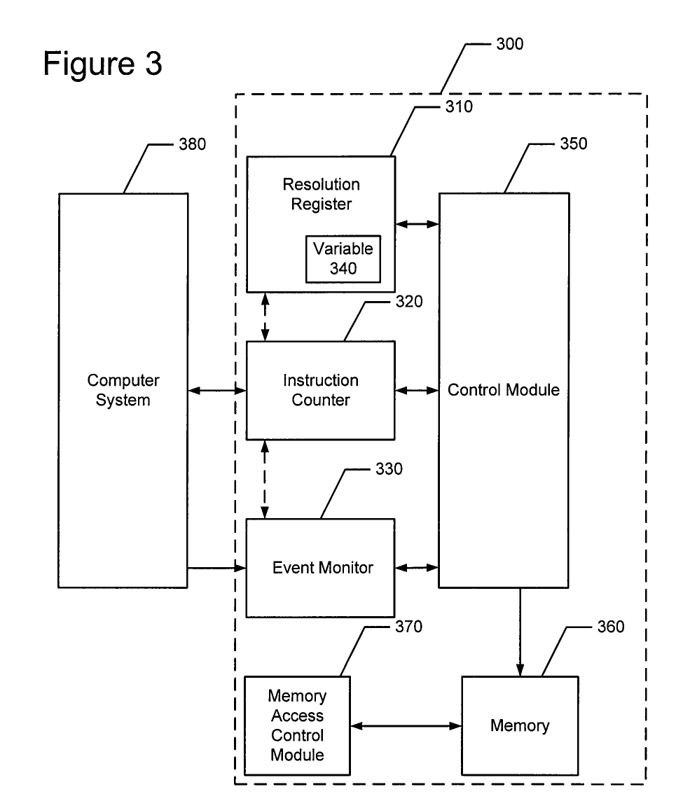

FIG. 3 shows an apparatus 300 according to another embodiment of the present invention. Apparatus 300 is comprised of components similar to those of apparatus 100. For the sake of brevity, the description of FIG. 3 will focus on distinguishing features of this embodiment.

The apparatus 300 measures events in the computer system 380 directly and dynamically as events per a variable number of executed instructions. The resolution register 310, stores a limit variable 340, which represents the number of instructions executed by the system that lapse before a result is output. The counter 320 counts the instructions executed by the system. The monitor 330 is configured to monitor the individual events executed during the execution of each instruction by the system. When the counter 320 has counted a number of instructions equal to the limit variable 340 in the resolution register 310, a result is output by the event monitor 330 to the control module 350.

The embodiment of FIG. 3 is shown as having a single apparatus 300 used to profile the computer system 380 at a single resolution. Alternatively, a plurality of apparatuses 300 may be coupled to the same computer system 380 to output results at varied resolutions simultaneously.

The embodiments of FIGS. 2 and 3 can be combined and used to profile a single computer system. The results produced by each would be stored in the same or separate memories. Utilizing both embodiments would provide system profiling information about both the instructions per variable number of CPU cycles and events per variable number of instructions. The memory or memories of this combined embodiment would store system data including but not limited to one or more of the system parameters of the instructions and events monitored, timestamps, instruction pointer values, data read addresses, executed code, and accessed data structures, and event pointer values. Parallel measurements, for example results at different resolutions, could be concurrently stored in the memory or memories. Additionally, the width of the stored results, the bit range of the results, could be adjusted to the set resolution.

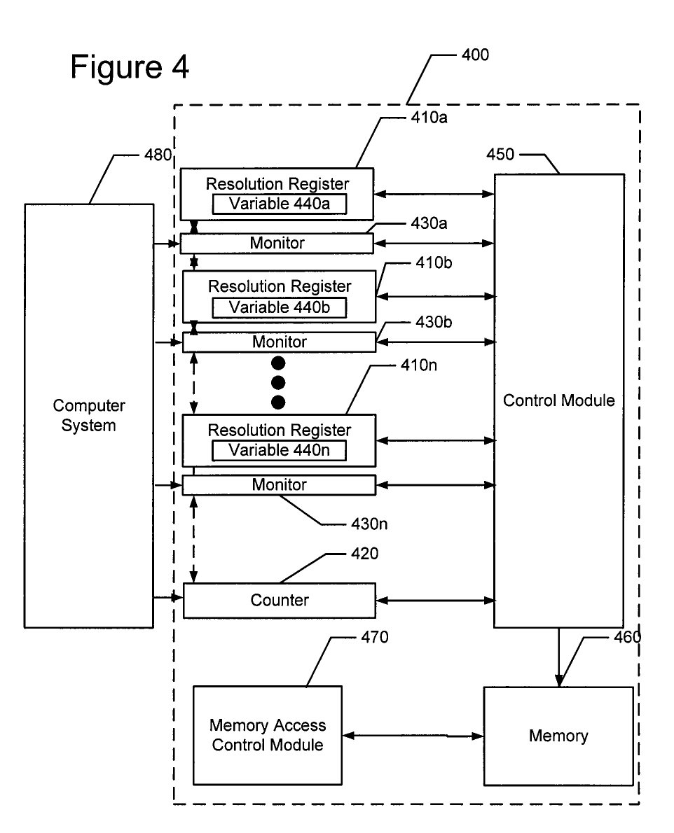

FIG. 4 shows an apparatus 400 according to another embodiment of the present invention. Apparatus 400 is comprised of components similar to those of apparatus 100. For the sake of brevity, the description of FIG. 4 will focus on distinguishing features of this embodiment.

The apparatus 400 contains a plurality of resolution registers 410a-410n and a plurality of monitors, 430a-430n. Each resolution register 410a-410n is paired with a corresponding monitor 430a-430n. Each resolution register 410a-410n contains its own limit variable 440a-440n. Thus, each pair can generate a separate result while profiling the system 480. For example, limit variable 440a is set to three while limit variable 440b is set to four. Thus, when the counter 420 reaches three, monitor 430a outputs a result. Then, when the counter 420 reaches four, monitor 430b outputs a result. In this manner, results are output at different resolutions. The memory 460 in this embodiment is configured to store the results at each of the various resolutions.

Results are generated on an ongoing basis because once the monitor in a pair outputs a result to the control monitor 450, the respective monitor 430 preferably resets to begin monitoring operations per cycle based on counter 420. For example, after a result is produced for resolution register 410a and monitor 430a, monitor 430a starts monitoring occurrences per operation anew, counting the first operation counted by the counter 420 as the first operation and monitoring every occurrence moving forward from there until the number of operations counted by counter 410 is again equal to the limit variable 440a in the resolution register 410a. Then, another result is output by the control module 450. This routine continues to produce additional results.

In this embodiment, control module 450 controls whether a pair is producing an output at a given time, i.e., whether a pair is on or off. The control monitor 450 causes the pairs to work at the same time so that results are continuously produced at various resolutions.

Alternatively, the control monitor 450 is configured to activate certain pairs only when the results produced by other pairs meet or exceed a certain value. For example, if a first pair, resolution register 410a and monitor 430a, produce a result at ten operations (limit variable 440a is ten), the control monitor 450 can be set to turn a second pair with a higher or lower resolution on only if the result of resolution register 410a and monitor 430a indicate that more than twenty occurrences execute per every ten operations. Thus, the rate measured by a certain pair at a certain variable can be used by the control monitor 450 to start and stop the result production of certain pairs. In this manner, parallel measurements or results, for example at different resolutions, can be started and stopped dependent from each other and can be extended only where it is necessary.

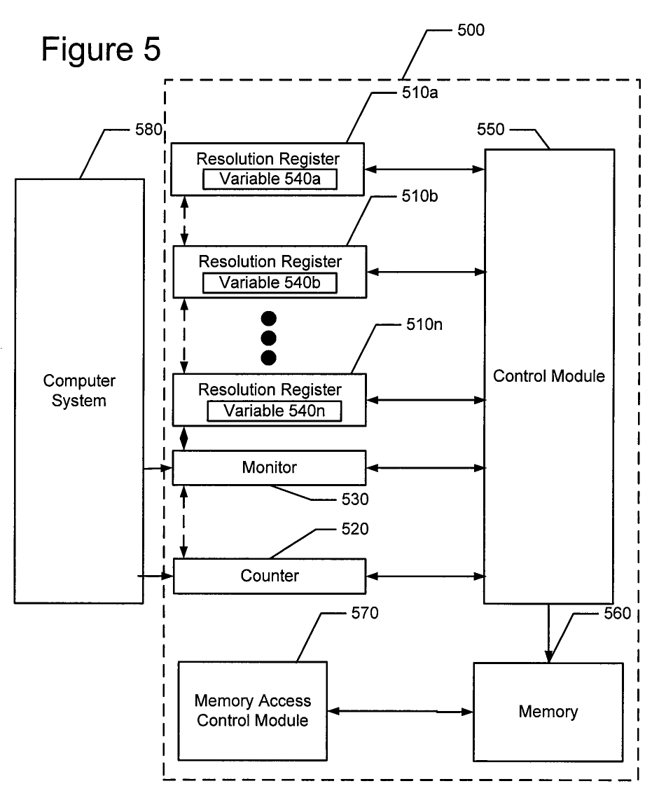

FIG. 5 shows an apparatus 500 according to another embodiment of the present invention. Apparatus 500 is comprised of components similar to those of apparatus 100. For the sake of brevity, the description of FIG. 5 will focus on distinguishing features of this embodiment.

The apparatus 500 profiles the computer system 580 at different resolutions using a plurality of resolution registers 510a-510n and a single monitor 530. Each resolution register contains a respective limit variable 540a-540n. The monitor 530 monitors occurrences per operation and the counter 520 counts the operations. When the counter 520 has counted a number of operations of the system equal to any limit variable 540a-540n in a resolution register 510a-510n, a result is output to the control module 550 by the monitor 530.

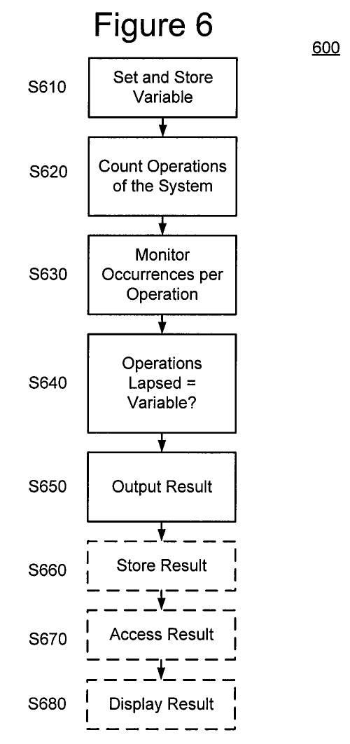

FIG. 6 is a flow diagram of a method 600 according to an embodiment of the present invention. The method generates results, also known as system measurements that indicate system performance. The method measures executed instructions as measurements of the actual CPU power in the hardware directly and dynamically and/or the events per executed instructions by the system. The number of CPU cycles or executed instructions at which the measurement is taken varies in accordance with a limit variable that is set and stored.

As with the apparatus, the semantics are such that operations typically refer to CPU cycles when occurrences refer to executed instructions. Alternatively, operations typically refer to executed instructions when occurrences refer to events.

According to this method, a limit variable is set and stored (S610). The limit variable represents the number of operations that lapse before a measurement of the system is taken, i.e., a result is produced. The variable is referred to as the resolution at which measurements are taken (results are produced).

In order to measure the number of occurrences per a variable number of operations, the number of operations of the system is continuously counted (S620). This provides a base so a measurement or result may be produced regardless of the value of the variable.

The number of occurrences is monitored continuously during every counter operation (S630) because before a measurement of occurrences is taken at a variable number of operations, operations are counted. Monitoring refers to both counting the number of occurrences and recording the substance of these occurrences. Monitoring includes observing the origin of each occurrence, the program code or data repository from which the occurrence originated. Because monitoring is continuous, results or measurements are available regardless of the value of the variable.

The semantics are such that occurrences refer to executed instructions when (S620) counts CPU cycles. Occurrences refer to events when (S620) counts executed instructions.

The counting (S620) and monitoring (S630) continue until the number of operations that have lapsed is equal to the limit variable (S640). If the values are equal, a result, a measurement, is output (S650). Results include but are not limited to rates of instructions per cycle, events per instruction, system data, including but not limited to one or more of the system parameters of the instructions, timestamps, instruction pointer values, data read addresses, executed code, and accessed data structures.

Once a result has been produced, this result is optionally stored (S660), accessed (S670) and displayed in a readable format (S680).

In this method, the output is preferably controlled by predetermined criteria, such as a minimum number of occurrences per operation. For example, the method produces a result only if at least three occurrences are monitored during three operations.

Although FIG. 6 displays the method as being executed in a specific order, no specific order is intended. For example, the resolution, that is the variable, may be set (S610) after the counting (S620) and monitoring (S630) have commenced.

Although the apparatus and method disclosed profile a system by either monitoring events per instruction or instruction per CPU cycle, those skilled in the art will appreciate numerous modifications therefrom, including but not limited to the consolidation of certain modules or the use of additional modules. It is intended that the appended claims cover all such modifications and variations as fall within the true spirit of this present invention.

1. An apparatus configured to profile a system, comprising:
a resolution register configured to store a variable;
a counter configured to count operations of the system; and
a monitor configured to monitor occurrences during each operation of the system,
wherein a result is output when a value of the counter is equal to the variable stored in the resolution register.

2. The apparatus of claim 1, further comprising:
a plurality of resolution registers; and
a plurality of monitors,
wherein each monitor is paired to a corresponding resolution register.

3. The apparatus of claim 1, further comprising:
a plurality of resolution registers, wherein the monitor outputs a result every time the value in the counter equals the variable in any resolution register.

4. The apparatus of claim 1, further comprising:
a control module configured to control the output of the result from the monitor.

5. The apparatus of claim 2, further comprising:
a control module configured to control the output of the result of each of the pairs.

6. The apparatus of claim 1, wherein the counter is a cycle counter and the monitor is an instruction monitor.

7. The apparatus of claim 2, wherein the counter is a cycle counter and the monitor is an instruction monitor.

8. The apparatus of claim 6, further comprising:
a memory configured to store the result.

9. The apparatus of claim 8, further comprising:
a memory access control module configured to read the result stored in the memory.

10. The apparatus of claim 7, further comprising:
a memory configured to store the result.

11. The apparatus of claim 10, further comprising:
a memory access control module configured to read the result stored in the memory.

12. The apparatus of claim 1, wherein the counter is an instruction counter and the monitor is an event monitor.

13. The apparatus of claim 2, wherein the counter is an instruction counter and the monitor is an event monitor.

14. The apparatus of claim 12, further comprising:
a memory configured to store the result.

15. The apparatus of claim 14, further comprising:
a memory access control module configured to read the result in stored in the memory.

16. The apparatus of claim 13, further comprising:
a memory configured to store the result.

17. The apparatus of claim 16, further comprising:
a memory access control module configured to read the result in stored in the memory.

18. The apparatus of claim 1 wherein the system comprises one or more CPUs.

19. The apparatus of claim 2 wherein the system comprises one or more CPUs.

20. A method for profiling a system, comprising:
storing a first variable;
counting the operations of the system;
counting occurrences during each operation of the system; and
outputting a first result, which is based on the occurrences per operation, when the number of operations is equal to the stored first variable.

21. The method of claim 20, further comprising:
controlling the outputting based on predetermined criteria.

22. The method of claim 20, further comprising:
determining a threshold value;
storing a second variable;
evaluating whether the first result is equal to the threshold value;
begin counting occurrences during each operation of the system when the first result is equal to the threshold value; and
outputting a second result, which is based on the occurrences per operation,
when the number of operations is equal to the stored second variable.

23. The method of claim 20, further comprising:
storing at least one of the first result and system data.

24. The method of claim 23, further comprising:
accessing the first result; and
displaying the first result.

25. The method of claim 23, further comprising:
controlling the storing of the system data based on the first result.
